(19) United States
(12) Patent Application Publication
(10) Pub. No.: US 2011/0246318 A1
(43) Pub. Date: Oct. 6, 2011

(54) SYSTEMS AND METHODS FOR FACITIATING TAX STATUS CATEGORIZATION OVER A NETWORK

(75) Inventors: Timothy Ross Coulter, Morgan Hill, CA (US); Prashant Jamkhedkar, Sunnyvale, CA (US)

(73) Assignee: EBAY INC., San Jose, CA (US)

(21) Appl. No.: 12/754,035

(22) Filed: Apr. 5, 2010

(51) Int. Cl. G06Q 40/00; G06Q 30/00; G06Q 10/00; G06Q 20/00

(52) U.S. Cl. 705/26.1; 705/31; 705/30

(57) ABSTRACT

In accordance with one or more embodiments of the present disclosure, a system and method for facilitating electronic commerce over a network includes communicating with a user via a user device and a merchant via a merchant device over the network, receiving a purchase request from the user via the user device over the network, determining tax parameters for the purchase request based on information related to the location of the user, the location of the merchant, and the type of item requested for purchase in the purchase request, automatically calculating tax for the purchase request based on the tax parameters, processing the purchase request, and storing transaction information related to the processed purchase transaction including tax information.

### BACKGROUND

1. Technical Field

The present invention generally relates to facilitating electronic commerce over a network and, more particularly, to facilitating tax status categorization over a network.

2. Related Art

In online financial transactions, users search for and purchase products and services through electronic communications with online merchants over electronic networks, such as the Internet. During the course of these purchase transactions, users may provide payment to a transaction service provider in various ways including, for example, credit cards, electronic fund transfers, and other payment techniques offered by the service providers.

Typically, when shopping at a particular website, users select items to purchase by clicking on a link for a specific item. The selected items are placed on reserve in some type of virtual shopping cart. When done shopping, the user is directed to checkout and provide some form of payment for the selected items. At this point, a tax may be assessed and/or calculated for the items selected for purchase.

The conventional tax structure is typically based on the idea that a person is buying a product from a merchant. For instance, there may be one person, one tax rate, and one tax entity for a particular product. In general, the Internet increases the complexity of purchase transactions. For example, purchase transactions may involve multiple locations, multiple taxing entities, and various other factors that may significantly increase the difficulty related to calculating and apportioning taxes. With the event of increased taxation on Internet, any taxation models may be complex to implement and manage when these factors are taken into consideration. Offloading the effort for the different entities in the taxation process may be extremely valuable to governments, merchants, and service providers.

As such, there exists a need to provide a convenient implementation of tax assessment for network based financial transactions. Moreover, there exists a need to improve handling of shopping carts and reserved items in online purchase transactions.

### SUMMARY

To overcome the deficiencies of conventional tax calculating mechanisms, the present disclosure provides a tax service adapted to automatically calculate tax and apportionment based on location of the buyer, location of the merchant, taxable rates, product type, and/or various other characteristics that may effect overall taxation for network based financial transactions in the tax process. The tax service may be implemented by a merchant as, for example, a choice for payment. The tax service may be adapted to allow taxation entities to be creative in tax strategy and use fee application. The tax service may provide a means for a service provider to establish a working relationship with government entities.

Embodiments of the present disclosure provide systems and methods for facilitating electronic commerce including facilitating tax status categorization over a network. The tax service is based on calculating taxes for purchases on a network, such as the Internet, based on where, when, and how a product is purchased. The tax service is adapted to allow correct taxes to be applied to purchases based on characteristics of the purchase (e.g., location, time, type of product, etc.) and the purchaser. Any relevant tax data and information is supplied to the seller through a network based tax service provided by a service provider.

In one implementation, the service provider provides the network based tax service to the seller to identify the location of the purchaser, location of the seller, and other pertinent information, and to determine the tax rate and status of the product being purchased. In one example, this may be achieved via a backend database that includes mapping information or any other automatic classification information. In another example, the tax service may use a plug-in module that automatically calculates the correct tax on Internet purchases based on buyer location, seller location, and type of items, products, and/or services proffered for sale by the seller. Once a purchase is completes and taxes are collected, the tax may then be apportioned to various taxing entities.

In accordance with one or more embodiments of the present disclosure, a system and method for facilitating electronic commerce over a network includes communicating with a user via a user device and a merchant via a merchant device over the network, receiving a purchase request from the user via the user device over the network, determining tax parameters for the purchase request based on information related to the location of the user, the location of the merchant, and the type of item requested for purchase in the purchase request, automatically calculating tax for the purchase request based on the tax parameters, processing the purchase request, and storing transaction information related to the processed purchase transaction including tax information.

In various implementations, the system and method may include obtaining user information from the purchase request, and notifying the user of tax information over the network including the tax parameters and the calculated tax for the purchase request based on the tax parameters. The system and method may include obtaining merchant information from the purchase request, and notifying the merchant of tax information over the network including the tax parameters and the calculated tax for the purchase request based on the tax parameters. The system and method may include obtaining tax entity information from the purchase request, identifying one or more tax entities related to the purchase request based on the location of the user, the location of the merchant, and the type of item requested for purchase in the purchase request, and notifying one or more tax entities of tax information over the network including the tax parameters and the calculated tax for the purchase request based on the tax parameters.

In various implementations, the system and method may include receiving payment for one or more items requested for purchase in the purchase request including payment for tax, dispersing tax to one or more tax entities related to the purchase request based on the location of the user, the location of the merchant, and the type of item requested for purchase in the purchase request, and storing transaction information related to the received payment including the payment for tax and the dispersion of tax.

In various implementations, the system and method may include applying a plurality of different tax rates to the purchase request based on information related to the location of the user, the location of the merchant, and the type of item requested for purchase in the purchase request. The system and method may include applying a first tax rate to the purchase request based on information related to the location of the user, applying a second tax rate is applied to the purchase request based on information related to the location of the merchant, and applying a third tax rate is applied to the purchase request based on information related to the type of item requested for purchase in the purchase request.

In various implementations, the system and method may include prompting the user to login over the network after receiving the purchase request from the user via the user device over the network, receiving user information including user identity information from the user via the user device over the network, verifying the identity of the user based on the user information, and verifying a user account related to the user. In one aspect, transaction information includes tax information and may be stored as part of an account related to the user, and the account related to the user may include information related to the user including identification information.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system adapted to facilitate electronic commerce including tax status categorization over a network, in accordance with embodiments of the present disclosure.

FIGS. 2A-2B show various methods to facilitate electronic commerce including tax status categorization over a network, in accordance with embodiments of the present disclosure.

FIG. 3A shows a buy item process to facilitate electronic commerce over a network, in accordance with embodiments of the present disclosure.

FIG. 3B shows a government tax dispersion process to facilitate electronic commerce over a network, in accordance with embodiments of the present disclosure.

FIG. 3C shows a scenario flow diagram depicting an implementation of the buy item process of FIG. 3A and the government tax dispersion process of FIG. 3B, in accordance with embodiments of the present disclosure.

FIG. 4 shows a tax service system adapted to facilitate electronic commerce including facilitating tax status categorization over a network, in accordance with embodiments of the present disclosure.

FIG. 5 shows a merchant onboarding process adapted to facilitate electronic commerce including facilitating tax status categorization over a network, in accordance with embodiments of the present disclosure.

FIG. 6 shows a block diagram of a computer system suitable for implementing one or more embodiments of the present disclosure.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure provide systems and methods for facilitating electronic commerce including facilitating tax status categorization over a network. In one implementation, tax status categorization includes automatically calculating tax on Internet purchases based on buyer location, seller location, and/or type of items purchased. In one aspect, taxation on Internet purchases may be complicated due to different tax rates for different taxing entities and different tax rates for different products. As such, tax status categorization automatically calculates tax, and tax information is provided to the seller, buyer, and/or taxing entities. The tax may be apportioned to various taxing entities. Taxing entities may utilize this information to revise tax rates for different products, etc. These and other aspects of the present disclosure are described in greater detail herein.

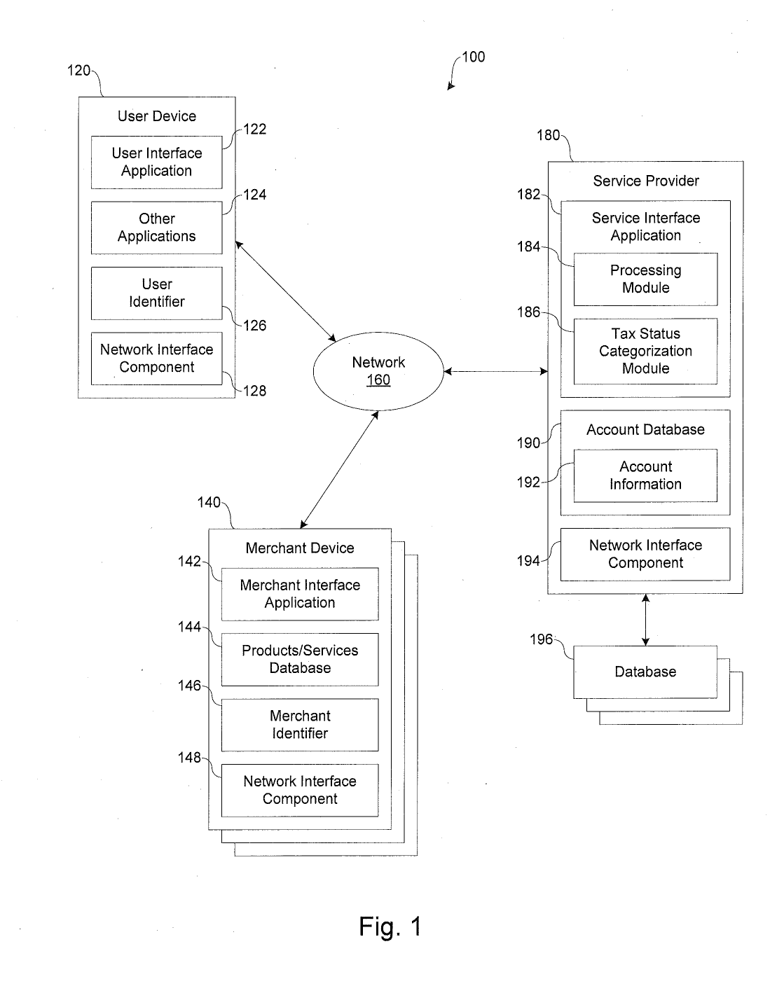

FIG. 1 shows one embodiment of a system 100 adapted for facilitating electronic commerce including facilitating tax status categorization over a network 160, such as the Internet and/or a mobile communication network. As shown in FIG. 1, the system 100 includes a user device 120 (e.g., a client, customer, or consumer device) adapted to interface with one or more merchant devices 140 (e.g., one or more business entities proffering items, products, and/or services for purchase), and a service provider 160 (e.g., a network based transaction service provider, such as a payment processing and/or settlement transaction provider) over the network 160.

In one aspect, referring to electronic commerce, users may be taxed for purchases on the network 160, such as the Internet, based on where, when, and how an item, product, and/or service is purchased. For example, a user in the state of Texas may purchase an item from a merchant in the state of California over the Internet, and the taxes may be different than if a user in the state of Maine purchased the same item from a merchant in the country of Mexico over the Internet. Embodiments of the present disclosure allow for specific tax rates to be identified and applied to a purchase based on one or more purchase parameters, such as location, time, etc., related to the item purchased, the location of the purchaser (e.g., the user 120), and/or the location of the merchant 140. The tax information related to the purchase may be provided to the purchaser (e.g., the user 120) and/or the merchant 140 over the network 160 by the service provider 180.

In one implementation, the service provider 180 may provide a network service to the one or more merchants 140 that is adapted to automatically calculate tax for network based purchases based on buyer location, seller location, and type of items purchased. The network service may be adapted to determine a tax rate based on mapping information and/or various other automatic classification information. Once collected by the service provider 180, the tax may then be apportioned to the various taxing entities or authorities.

In one aspect, as taxation on Internet purchases becomes more complicated, buyers, sellers, and taxing entities seek a simplified mechanism to calculate and apportion taxes on Internet purchases. Based on mathematical models, a tax may be computed based on buyer location, seller location, and item and/or service purchased. In many instances, calculating proper taxes may be highly complex due to the different tax rates for different taxing entities and the different tax rates for different products. In one embodiment, the service provider 180 utilizes a tax categorization module 186 to automatically calculate purchase taxes, and tax information may be provided to the seller, buyer, and/or taxing entities. The tax may be apportioned to various taxing entities, such as in an escrow. Taxing entities may utilize the tax information to revise tax rates for different locations, products, etc.

The network 160, in one embodiment, may be implemented as a single network or a combination of multiple networks. For example, the network 160 may include a wireless telecommunications network (e.g., cellular telephone network) adapted for communication with one or more other communication networks, such as the Internet. In other examples, the network 160 may include the Internet, one or more intranets, landline networks, wireless networks, and/or one or more other appropriate types of communication networks. As such, in various implementations, the user device 120, the one or more merchant devices 140, and the service provider 180 may be associated with a particular link (e.g., a link, such as a URL (Uniform Resource Locator) to an IP (Internet Protocol) address).

The user device 120, in various embodiments, may be implemented using any appropriate combination of hardware and/or software configured for wired and/or wireless communication over the network 160. In one embodiment, the user device 120 may be implemented as a mobile communication device (e.g., wireless cellular phone) adapted for communication with the network 160. In other embodiments, the user device 120 may be implemented as a personal computer (PC), a personal digital assistant (PDA), a notebook computer, and/or various other generally known types of wired and/or wireless computing devices for communication with the network 160. It should be appreciated that the user device 120 may be referred to as a client device or a customer device without departing from the scope of the present disclosure.

The user device 120, in one embodiment, includes a user interface application 122, which may be utilized by a user to conduct network based financial transactions (e.g., remote network based electronic commerce) with the one or more merchant devices 140 and/or the service provider 180 over the network 160. In various implementations, the user interface application 122 may be implemented as a network commerce application and/or a mobile commerce application to initiate, track, manage, and store data and information (e.g., tax data and information) related to network based electronic commerce for viewing, searching, and/or purchasing items, products, and/or services over the network 160. In one aspect, the user device 120 may be linked to an account with the service provider 160 for direct and/or automatic settlement of purchase requests including tax payments between a user and the one or more merchant devices 140 via the user interface application 122.

In one embodiment, the user interface application 122 comprises a software program, such as a graphical user interface (GUI), executable by a processor that is configured to interface and communicate with the one or more merchant devices 140 and/or the service provider 180 via the network 160. In one implementation, the user interface application 122 comprises a browser module adapted to provide a network interface to browse information (e.g., tax rate information) available over the network 160. For example, the user interface application 122 may be implemented, in part, as a web browser to view and search various types of information available over the network 160. In another example, the user is able to access merchant websites of the one or more merchant devices 140 over the network 160 to view, search, and select items, products, and/or services for purchase, and the user is able to purchase selected items, products, and/or services from the one or more merchant devices 140 via the service provider 180. As such, the user may conduct network based financial transactions (e.g., electronic commerce including tax calculations and payments) with the one or more merchant devices 140 via the service provider 180.

In one embodiment, upon user instruction, the user interface application 122 may be installed and/or run on the user device 120. The user may run the user interface application 122 on the user device 120 to access the service provider 180 via the network 160. In one aspect, upon installation and/or execution of the user interface application 122, the user may be prompted to establish a user account for login with the service provider 180, wherein the user may use the user interface application 122 and the user device 120 to access the service provider 180 via the network 160. When establishing a user account, the user may be asked to provide personal information, such as name, location information (e.g., address), phone number, etc., and financial information, such as banking information, credit card information, etc. In another aspect, referring to FIG. 1, information related to the user may be packaged as a user identifier 126, which is described in greater detail herein.

The user device 120, in various embodiments, may include other applications 124 as may be desired in one or more embodiments of the present disclosure to provide additional features available to the user. In various examples, such other applications 124 may include security applications for implementing user-side security features, programmatic client applications for interfacing with appropriate application programming interfaces (APIs) over the network 160, and/or various other types of generally known programs and/or software applications. In various other examples, other applications 124 may interface with the user interface application 122 for improved efficiency and convenience. In one example, files, data, and/or information may be imported from various types of accounting software (e.g., a spreadsheet application) directly into the user interface application 122 for improved tracking of payments and settlements related to purchases via the network 160. Accordingly, it should be appreciated that the user interface application 122 and each of the other applications 124 are adapted to make API calls over the network 160.

The user device 120, in various embodiments, may include the user identifier 126, which may be implemented as operating system registry entries, cookies associated with the user interface application 122, identifiers associated with hardware of the user device 120, and/or various other appropriate identifiers. The user identifier 126 may include one or more attributes related to the user, such as personal information related to the user (e.g., one or more user names, passwords, photograph images, biometric ids, addresses, phone numbers, etc.) and banking information (e.g., one or more banking institutions, credit card issuers, user account numbers, security data and information, etc.). In various aspects, the user identifier 126 may be passed with user transaction requests to the service provider 180 via the network 160, and the user identifier 126 may be utilized by the service provider 180 to associate the user with a particular user account maintained by the service provider 180.

The user device 120, in one embodiment, may include a network interface component (NIC) 128 adapted for communication with the network 160. In various implementations, the network interface component 128 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 128 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The one or more merchant devices 140, in one embodiment, may be implemented using any appropriate combination of hardware and/or software configured for wired and/or wireless communication over the network 160. In various implementations, the merchant devices 140 may be implemented as a network server, a personal computer (PC), a personal digital assistant (PDA), a notebook computer, and/or various other generally known types of wired and/or wireless computing devices for communication with the network 160. In another implementation, the merchant device 140 may be implemented as a mobile device (e.g., a wireless cellular phone) adapted for communication with the network 160.

In another embodiment, the one or more merchant devices 140 may be maintained as one or more network servers by one or more business entities (e.g., merchant sites, resource information sites, utility sites, real estate management sites, social networking sites, etc.) offering various items, products, and/or services for purchase and payment, which may need registration of user identity information as part of offering the items, products, and/or services to one or more users over the network 160. Accordingly, each of the one or more merchant devices 140 may comprise at least one network based server in communication with the network 160 having a merchant interface application 142 and a products/services database 144 for presenting and identifying one or more available items, products, and/or services for purchase via the network 160, which may be made available to the user device 120 for viewing and purchase by the user. In one aspect, each of the network based merchant servers may be accessible via a mobile communication device (e.g., wireless cellular phone) for management purposes. For example, each merchant entity may remotely access and interact with their own network based merchant server via a mobile communication device for management purposes.

In one embodiment, each of the merchant devices 140 includes the merchant interface application 142, which may be utilized by the one or more merchant devices 140 to conduct network based financial transactions (e.g., remote network commerce, such as shopping, purchasing, bidding, etc.) with one or more users via one or more user devices 120 and/or the service provider 180 over the network 160. For example, the merchant interface application 142 may be implemented as an electronic commerce application to initiate, track, manage, and store data and information (e.g., tax data and information) related to remote network based commerce for the viewing, searching, and purchasing of items, products, and/or services over the network 160. In one aspect, each merchant device 140 may be linked to an account with the service provider 160 for direct and/or automatic settlement of purchase requests including tax calculation and collection between each merchant 140 and one or more users via the merchant interface application 142.

In one implementation, the merchant interface application 142 comprises a software program, such as a GUI, executable by a processor configured to interface and communicate with one or more users via one or more user devices 120 and/or the service provider 180 via the network 160. In another implementation, merchant interface application 142 comprises a network interface module that makes information available to the user device 120 over the network 160. For example, the merchant interface application 142 may be implemented, in part, as a website manager to provide, list, and present information to the user device 120 via the network 160. In another example, each merchant 140 is capable of providing one or more network based merchant websites to allow viewing, searching, and selecting of items, products, and/or services for purchase by the user via the user device 120, and the user is able to purchase items, products, and/or services from the one or more merchant devices 140 via the merchant websites and the service provider 180. As such, each of the merchant devices 140 may conduct financial transactions with the user via the merchant interface application 142 and the service provider 180.

In various implementations, the merchant interface application 142 may include a marketplace application, which may be configured to provide transaction information related to the products and/or services database 144 to the user interface application 122 of the user device 120 via the network 160. In one aspect, the transaction information may include tax related data and information including tax rates. For example, the user may interact with the merchant 140 via the marketplace application through the user interface application 122 over the network 160 to search and view various items, products, and/or services available for purchase from the products/services database 144. In one implementation, the marketplace application may include a checkout module adapted to facilitate online financial transactions with the user 120, and the checkout module may be adapted to accept payment from the user 120 and process the payment via interaction with the service provider 180.

In one implementation, upon merchant instruction, the merchant interface application 142 may be installed and/or run on each merchant device 140. Each merchant may run the merchant interface application 142 on their merchant device 140 to access service provider 180 via the network 160. In one aspect, upon installation and/or execution of the merchant interface application 142, each merchant may be prompted to establish a merchant account for login with the service provider 180, wherein each merchant may use merchant interface application 142 and merchant device 140 to access the service provider 180 via the network 160. In one aspect, when establishing a merchant account, each merchant may be asked to provide business information, such as business name, location information (e.g., address), phone number, etc., and financial information, such as banking information, credit card information, taxing entity, etc. In another aspect, information related to the merchant may be packaged as a merchant identifier 146, which is described in greater detail herein.

In various implementations, the merchant interface application 142 may include one or more other applications as may be desired to provide additional features available to the merchant. In various examples, such other applications may include security applications for implementing user-side security features, programmatic applications for interfacing with appropriate application programming interfaces (APIs) over the network 160, and/or various other types of generally known programs and/or software applications. In various other examples, files, data, and/or information may be imported from various types of accounting software (e.g., a spreadsheet application) directly into the merchant interface application 142 for improved tracking of payments and settlements, including tax payments and settlements, related to electronic commerce via the network 160. As such, it should be appreciated that merchant interface application 142 and any other application may be adapted to make API calls over the network 160.

Each of the merchant devices 140, in various embodiments, may include at least one merchant identifier 146, which may be included as part of the one or more items, products, and/or services made available for purchase so that, e.g., particular items, products, and/or services are associated with particular merchant devices 140. In one implementation, the merchant identifier 146 may include one or more attributes and/or parameters related to the merchant, such as business and/or banking information. For example, the merchant identifier 146 may be passed from each particular merchant 140 to the service provider 180 when the user selects an item, product, and/or service for holding, monitoring, and/or purchasing from each particular merchant 140. In one aspect, the merchant identifier 146 may be used by the service provider 180 to associate particular items, products, and/or services selected for purchase with a particular merchant account maintained by the service provider 180. In another aspect, the user may conduct financial transactions (e.g., selection, monitoring, purchasing, and/or providing payment for items, products, and/or services) with each merchant server 140 via the service provider 180 over the network 160.

In various embodiments, each of the one or more business entities having a related merchant server 140 may need to establish at least one merchant account with the service provider 180. When establishing a merchant account, each of the one or more business entities may need to provide business information, such as owner name, owner address, social security number, date of birth, phone number, email address, etc., and financial information, such as banking information, merchant account information, credit card information, payment processing information, etc.

In one embodiment, each merchant device 140 includes at least one network interface component (NIC) 148 adapted for communication with the network 160. For example, in various implementations, the network interface component 148 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 148 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in one embodiment, may be maintained by a network based transaction processing entity, which may provide processing for network based transactions including online information and/or financial transactions on behalf of the user via the user device 120 and/or each merchant device 140. As shown in FIG. 1, the service provider 180 includes a service interface application 182, which may be adapted to interact with the user device 120 and/or each merchant 140 over the network 160 to facilitate electronic commerce including processing tax data and information. In one example, a financial transaction may include the selection, purchase, and/or payment of items, products, and/or services by the user via the user device 120 from one or more merchant devices 140. The purchase and payment for selected items, products and/or services may include a tax assessment, which is described in greater detail herein. In one embodiment, the service provider 180 may be provided by network based transaction processing entity, such as PayPal, Inc. and/or eBay of San Jose, Calif., USA.

The service interface application 182, in one embodiment, is adapted to utilize a processing module 184 to process purchases and/or payments, including tax assessment, for financial transactions between the user device 120 and each of the merchant devices 140. In one implementation, the processing module 184 is adapted to resolve financial transactions through validation, delivery, and settlement. For example, the processing module 184 may be adapted to communicate with a clearing house, such as automated clearing house (ACH), to debit a user account related to the user according to an amount specific in a payment and credit therewith a merchant account related to a merchant. In another implementation, the processing module 184 is adapted to assess and disperse taxes for financial transactions through validation, delivery, and settlement. For example, tax assessment may include automatically calculating tax on Internet purchases based on buyer location, seller location, and/or type of items, products, and/or services purchased. Accordingly, the service interface application 182 in conjunction with the processing module 184 is adapted to settle indebtedness on behalf of a user between the user device 120 and each of the merchant devices 140, wherein accounts may be directly and/or automatically debited and/or credited, respectively, of monetary funds in a manner as accepted by the banking industry.

The service interface application 182, in one embodiment, is adapted to utilize a tax status categorization module 186 adapted to obtain tax data and information and provide tax assessment for network based financial transactions. In one implementation, the tax status categorization module 186 is adapted to provide users, customers, consumers, clients, buyers, merchants, sellers, and various taxing entities a simple, convenient, and efficient mechanism to calculate, assess, and apportion taxes on purchases made over the network 160, such as the Internet. For example, based on mathematical models, a tax may be calculated or assessed based on buyer location, seller location, and/or items, products, and/or services purchased by applying different rates for different taxing entities and different rates for the different items, products, and/or services. In one aspect, the tax status categorization module 186 is adapted to automatically calculate tax, and any related tax data and information may be provided to one or more of the buyer, seller, and/or taxing entities. The tax may be apportioned to one or more various taxing entities, such as in an escrow. Taxing entities may utilize the tax data and information to revise tax rates for different products, locations, etc.

In various implementations, the tax status categorization module 186 is adapted to automatically calculate a tax and apportionment based on a location of the user (e.g., client customer, consumer, etc.), location of the merchant, taxable rates, product type, and other characteristics that may affect the overall taxation for each entity involved in the tax assessment process. For example, the merchant may implement the tax status categorization module 186 as part of a checkout procedure or during a choice for payment. In another example, the tax status categorization module 186 allows taxation entities to be more creative in their tax and use fee applications. In still another example, the tax status categorization module 186 may provide the service provider 180 a means to establish a working partnership with government entities for tax calculation, assessment, and apportionment.

In various implementations, the tax status categorization module 186 may include one or more of the following attributes. For instance, the tax status categorization module 186 may be adapted to comprise a consistent, fair, and transparent model for network based taxation. The tax status categorization module 186 may be applicable to many different geographies, countries, states, and/or other taxation entities. The tax status categorization module 186 may comprise a service interface application that may be utilized by users, consumers, merchants, third parties, taxing entities, etc. The tax status categorization module 186 may be adapted to decouple tax rules from a conventional static transaction model. The tax status categorization module 186 may utilize the location of the seller and the purchaser to calculate tax. The tax status categorization module 186 may utilize a product type and/or a product category to calculate tax. The tax status categorization module 186 may be adapted to interface with relational databases (e.g., databases 196) to identify tax entities and tax rules of particular tax entities and/or tax authorities. It should be appreciated that the rules and calculations may be stored and/or processed by the service provider 180.

The service interface application 182, in one embodiment, may be adapted to utilize a notification module, which is adapted to notify users of tax assessments for network based financial transactions. In one implementation, the service interface application 182 in combination with the notification module may be adapted to notify or alert the user of tax data and information (e.g., tax rates, etc.) for network based financial transactions with notifications or alerts (e.g., email message, text message, voice message, etc.) provided over the network 160. In another implementation, the user may review tax data and information for network based financial transactions via the notifications or alerts.

The service application 182, in one embodiment, may be adapted to utilize a selection processing module to process and monitor user selection events during online shopping by the user via the user device 120. In one aspect, the selection processing module allows the service provider 180 to process and monitor user selections during online navigation and shopping events over the network 160. For example, the service provider 180 interfaces with the user device 120 via, e.g., a browser window to monitor the user and the user device 120 during navigation and shopping events on various merchant sites. The selection processing module may be used by the service provider 180 to monitor user selections of one or more items, products, and/or services. In another example, the selection processing module may be used by the service provider 180 to provide the user with estimated tax amounts for items, products, and/or services held in an online shopping cart.

The service provider 180, in one embodiment, may be configured to maintain one or more user accounts and merchant accounts in an account database 190, each of which may include account information 192 associated with one or more individual users and the one or more merchant devices 140. For example, account information 192 may include tax data and information related to the user and/or merchant, such as user location, merchant location, and/or type of items, products, and/or services proffered for sale by the merchant. It should be appreciated that the user may be considered a buyer or seller and proffer items, products, and/or services for sale over the network 160, without departing from the scope of the present disclosure. It should also be appreciated that the merchant may be considered a buyer or seller and proffer items, products, and/or services for sale over the network 160, without departing from the scope of the present disclosure.

In another example, account information 192 may include private financial data and information of the user and/or each merchant 140, such as one or more locations, addresses, account numbers, passwords, credit card information, banking information, or other types of financial information, which may be used to facilitate online financial transactions between the user and the one or more merchant devices 140. In various implementations, the methods and systems described herein may be modified to accommodate additional users and/or additional merchants that may or may not be associated with at least one existing user account and/or merchant account, respectively.

In one implementation, the user and/or user device 120 may have identity attributes stored with the service provider 180 as the user identifier 126, and the user and/or user device 120 may have credentials to authenticate or verify identity with the service provider 180. In one aspect, user attributes may include personal information and banking information, as previously described, including location, tax rates, etc. In other aspects, the user attributes may be passed to the service provider 180 as part of a login and/or transaction request, and the user attributes may be utilized by the service provider 180 to associate the user and/or the user device 120 with one or more particular user accounts in the account database 190 maintained by the service provider 180.

In another implementation, each of the merchants and/or merchant devices 140 may have identity attributes stored with the service provider 180 as merchant identifiers 146, and each of the merchant devices 140 may have credentials to authenticate or verify identity with the service provider 180. In one aspect, merchant attributes may include personal, business, and banking information, as previously described, including location, tax rates, etc. In other aspects, the merchant attributes may be passed to the service provider 180 as part of a login and/or transaction request, and the merchant attributes may be utilized by the service provider 180 to associate each of the merchant devices 140 with one or more merchant accounts in the account database 190 maintained by the service provider 180.

The service provider 180, in various embodiments, may include a network interface component (NIC) 194 adapted for communication with the network 160 and any network based communication devices including the network interface component 128 of the user device 120 and the network interface component 148 of each merchant 140. In various implementations, the network interface component 194 of the service provider 180 may include a wireless communication component, such as a wireless broadband component, a wireless satellite component, or various other types of wireless communication components including radio frequency (RF), microwave frequency (MWF), and/or infrared frequency (IRF) components adapted for communication with the network 160. In other various implementations, the network interface component 148 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in various embodiments, may include one or more databases 196 (e.g., internal and/or external databases) for storing and tracking information related to financial transactions, including tax data and information, between particular users, such as the user, the one or more merchant devices 140, and the service provider 180. In one implementation, the databases 196 may provide a historical survey of financial transactions between the user device 120, the one or more merchant devices 140, and the service provider 180. For example, the service interface application 182 may be adapted to monitor, track, log, and store transaction information, including tax data and information, related to network based electronic commerce between the user device 120, each merchant 140, and/or the service provider 180, and the stored transaction information is accessible from the databases 196 for assessment, analysis, maintenance, and settlement.

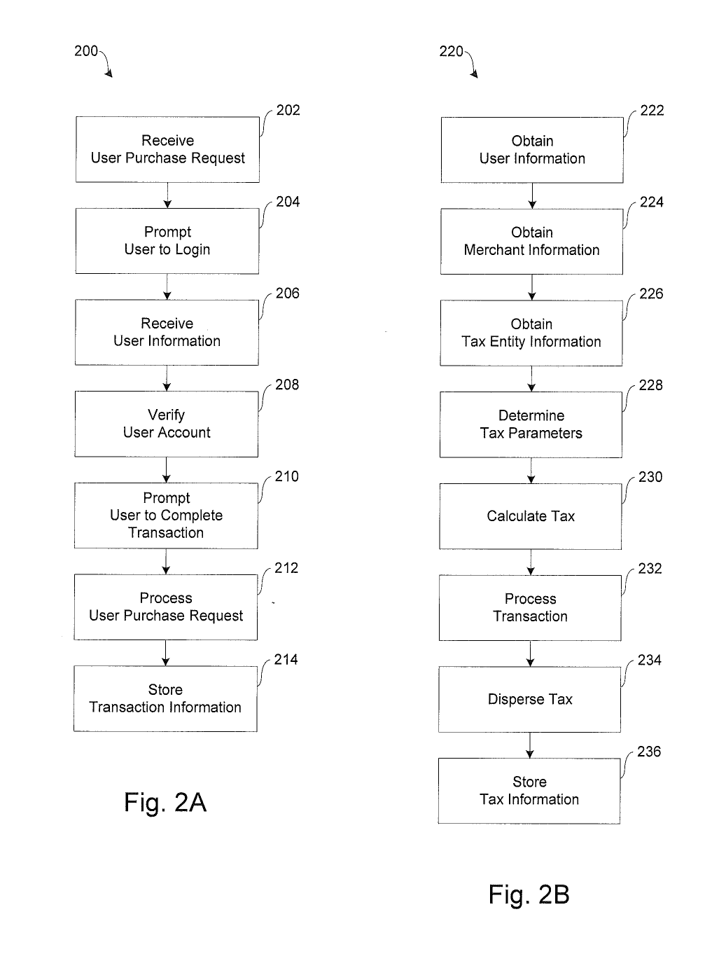

FIG. 2A shows one embodiment of a method 200 for facilitating electronic commerce including facilitating tax status categorization over a network 160. It should be appreciated that, for purposes of explanation, the method 200 of FIG. 2A is described in reference to the system 100 of FIG. 1, but should not be limited thereto.

Referring to FIG. 2A, the service provider 180 is adapted to receive a purchase request from a user via the user device 120 over the network 160 (block 202). For example, a user or buyer may visit an online merchant or seller website and navigate through the merchant's or seller's products and pages to select one or more items for purchase. The selected items are placed in a virtual shopping cart until checkout. When the user is done shopping, the user accesses a merchant webpage for viewing the selected items in the virtual shopping cart. At this merchant page, the user may decide to checkout (i.e., purchase) and select a link to the service provider 180 to request processing of the purchase transaction. Upon user selection, the service provider 180 receives a purchase request in reference to the shopping cart and the one or more items selected for purchase. In one implementation, the user purchase request includes information related to the transaction including user information (e.g., user name, user account, user location, etc.), merchant information (e.g., merchant name, merchant account, merchant location, and one or more items selected for purchase including item description, category, price, weight, size, etc.), and tax entity information (e.g., government tax data and information (e.g., country, federal, state, county, municipal, city, etc.). In one aspect, the tax entity information may include international tax data and information, such as foreign tax rates, foreign monetary exchange rates, etc.

The service provider 180 is adapted to prompt the user to login from the user device 120 over the network 160 (block 204). In one aspect, the user is logging in to the service provider 180 with an intention to checkout and purchase the items selected in the virtual shopping cart from the merchant as provided in the purchase request.

The service provider 180 is adapted to receive user information, such as identity data and information, from the user via the user device 120 over the network 160 (block 206). In one implementation, user identity information may include attributes related to the user, such as personal information related to the user (e.g., usernames, passwords, photograph images, biometric ids, addresses including location information, phone numbers, etc.) and banking information (e.g., banking institutions, credit card issuers, user account numbers, security information, etc.). In one aspect, the user identity information may be utilized by the service provider 180 to verify the identity of the user along with verifying tax information.

The service provider 180 is adapted to verify a user account related to the user in the account database 190 based on user information passed from the user device 120 over the network 160 (block 208). In one implementation, the service provider device 180 processes a user login request by attempting to locate and access an account related to the user in the account database 190. If the user is determined to be an existing user by the service provider 180, then the service provider 180 is adapted to verify the user account and user identity information provider by user 102 in the user login request by comparing the received user information with account information 192 stored as part of the user account in the account database 190. In one aspect, the service provider 180 may determine if the user account is current and active. In some instances, user account information may need to be updated, and as such, the service provider device 180 may prompt the user 102 to update user account information 188 in the user account for the user. The updated information may include updated tax data and information, including a change of address.

It should be appreciated by those skilled in the art that the service provider 180 may cancel the user login request at any time during the process of method 200 if, for example, it is determined by the service provider 180 that the user enters wrong information or the user is trying to access an account with criminal intent.

The service provider 180 is adapted to prompt the user to complete the requested transaction from the user device 120 over the network 160 (block 210). For example, in one implementation, the service provider 180 may prompt the user via the user device 120 to select a permission button to settle the debt including the tax with funds in the user account, which may be transferred from the user account to an account related to the merchant for purchases and/or another account (e.g., an escrow account) for the tax.

The service provider 180 is adapted to process the purchase request from the user via the user device 120 over the network 160 (block 212). In one implementation, the service provider 180 is adapted to utilize user information, merchant information, and tax entity information to determine tax parameters and calculate tax, and the service provider 180 may then process the transaction and disperse tax. In one aspect, processing the user purchase request of block 212 is described in reference to method 220 of FIG. 2B.

The service provider 180 is adapted to store transaction information related to the processed transaction (block 214). In one implementation, user information (e.g., attributes related to the user including user name, user account number, user location, etc.), merchant information (e.g., merchant name, merchant account, merchant location, and one or more items selected for purchase), tax entity information (e.g., country, federal, state county, city, etc.), and other transaction information related to the processed transaction may be stored as part of the user account in the account database 190. In another implementation, the service provider 180 may utilize one or more other databases (e.g., internal and/or external databases 196) for storing data and information related to financial transactions. Databases utilized by the service provider 180 may provide a historical survey of financial transactions between the user device 120, the one or more merchant devices 140, and the service provider 180. The service provider 180 may be adapted to monitor, track, log, and store transaction information, including tax data and information, related to network based electronic commerce between the user device 120, each merchant 140, and/or the service provider 180, and the stored transaction information is accessible from the databases 196 for assessment, analysis, maintenance, and settlement.

FIG. 2B shows one embodiment of a method 220 for facilitating electronic commerce including facilitating tax status categorization over a network 160. It should be appreciated that, for purposes of explanation, the method 220 of FIG. 2B is described in reference to the system 100 of FIG. 1 and the method 200 of FIG. 2A, but should not be limited thereto.

Referring to FIG. 2B, the service provider 180 is adapted to obtain user information from a user via the user device 120 over the network 160 (block 222). In one aspect, at least a portion of the user information may be received as part of a user purchase request received over the network 160, as described in reference to FIGS. 1-2A. In another aspect, the service provider 180 may obtain a portion of the user information from an account related to the user in the account database 190. User information may include attributes related to the user, such as personal information (e.g., username, password, photograph image, biometric id, location (e.g., address), phone numbers, etc.) and banking information (e.g., banking institution, credit card issuer, account number, security information, etc.). As such, the service provider 180 may obtain user information from the user purchase request and/or an account related to the user.

Along with user information, the service provider 180 is adapted to obtain merchant information from a user purchase request via the user device 120 over the network 160 when the user requests a purchase transaction (block 224). In one aspect, at least a portion of the merchant information may be received as part of a user purchase request received over the network 160, as described in reference to FIGS. 1-2A. In another aspect, the service provider 180 may locate an account related to the merchant in the account database 190 to obtain merchant information. In various implementations, merchant information may include attributes related to the merchant, such as business information (e.g., business name, location (e.g., address), phone number, etc.) and financial information (e.g., banking institution, credit card issuer, account numbers, security information, taxing authority, etc.). As such, the service provider 180 may obtain merchant information from the user purchase request and/or an account related to the merchant.

Along with user and merchant information, the service provider 180 is adapted to obtain tax entity information from a user purchase request via the user device 120 over the network 160 when the user requests a purchase transaction (block 226). In one aspect, at least a portion of the tax entity information may be received as part of a user purchase request received over the network 160, as described in reference to FIGS. 1-2A. In another aspect, the service provider 180 may obtain tax entity information from a database, such as databases 196. Tax entity information may include attributes related to taxing authorities for the buyer location and merchant location, such as government tax data and information (e.g., country, federal, state county, city, etc.) and applicable tax rates. Tax entity information may include international tax data and information, such as foreign tax rates, foreign monetary exchange rates, etc. As such, the service provider 180 may obtain tax entity information from the user purchase request and/or a database, such as databases 196.

The service provider 180 is adapted to determine tax parameters for a user purchase request (block 228) and calculate tax for a user purchase request based on the tax parameters (block 230). In one implementation, determining tax parameters includes identifying buyer location (e.g., user location), seller location (e.g., merchant location), and/or type of items, products, and/or services purchased. In another implementation, determining tax parameters includes identifying taxing entities (e.g., government agencies and taxing authorities) within these locations for taxable applications (e.g., applicable tax rates). In one aspect, the process is adapted to identify different tax rates for different taxing entities and different tax rates for different products based on buyer location and seller location. As such, tax is automatically calculated based on one or more of the tax parameters. Tax information may be provided to one or more of the buyer, seller, and/or taxing entities. Tax may be apportioned to various taxing entities and/or government agencies. Taxing entities may utilize this information to revise tax rates for different products, etc.

The service provider 180 is adapted to process a financial transaction for the user purchase request (block 232) and disperse tax for the processed financial transaction (block 234). In one aspect, the service provider 180 is adapted to process purchases, payments, and tax assessments for financial transactions between the user device 120 and the merchant devices 140. In aspect, the service provider 180 is adapted to resolve financial transactions and assess taxes through validation, delivery, and settlement. Accordingly, the service provider 180 is adapted to settle indebtedness on behalf of the user, the merchant, and tax entities, wherein accounts may be directly and/or automatically debited and/or credited, respectively, of monetary funds based on the processed financial transaction and calculated tax assessments in a manner as accepted by the banking industry.

The service provider 180 is adapted to store tax data and information related to the processed financial transaction and/or the user purchase request (block 236). In one aspect, the service provider 180 may utilize one or more databases (e.g., internal and/or external databases 196) for storing and tracking data and information related to financial transactions, including tax data, information, and assessments. Databases utilized by the service provider 180 may provide a historical survey of financial transactions between the user device 120, the one or more merchant devices 140, and the service provider 180. In one example, the service provider 180 may be adapted to monitor, track, log, and store transaction information, including tax data and information, related to network based electronic commerce between the user device 120, each merchant 140, and/or the service provider 180, and the stored transaction information is accessible from the databases (e.g., databases 196) for assessment, analysis, maintenance, and settlement.

In one aspect, as taxation on Internet purchases becomes highly complicated, buyers, sellers, and taxing entities may desire an convenient and easily implementable mechanism (e.g., a plug-in module) to calculate and apportion taxes on Internet purchases. Based on mathematical models, a tax may be computed based on buyer location, seller location, and the items, products, and/or services purchased. Tax calculation may be highly complicated due to the application of different rates for different taxing entities and different rates for different products. As such, in one example, a plug-in module for the tax service may be adapted to automatically calculate tax, and the tax data and information may be provided to the buyer, seller, and/or taxing entities. The tax may then be apportioned to various taxing entities, such as in an escrow account. Taxing entities may utilize this information to revise tax rates for different products, etc.

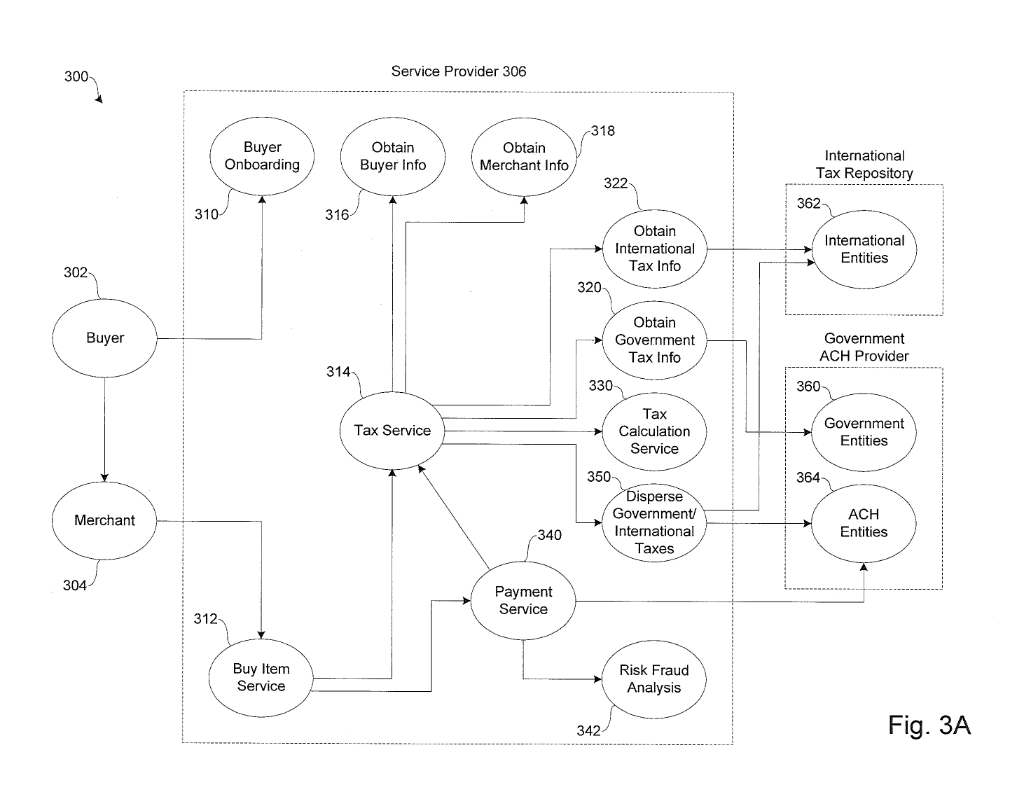

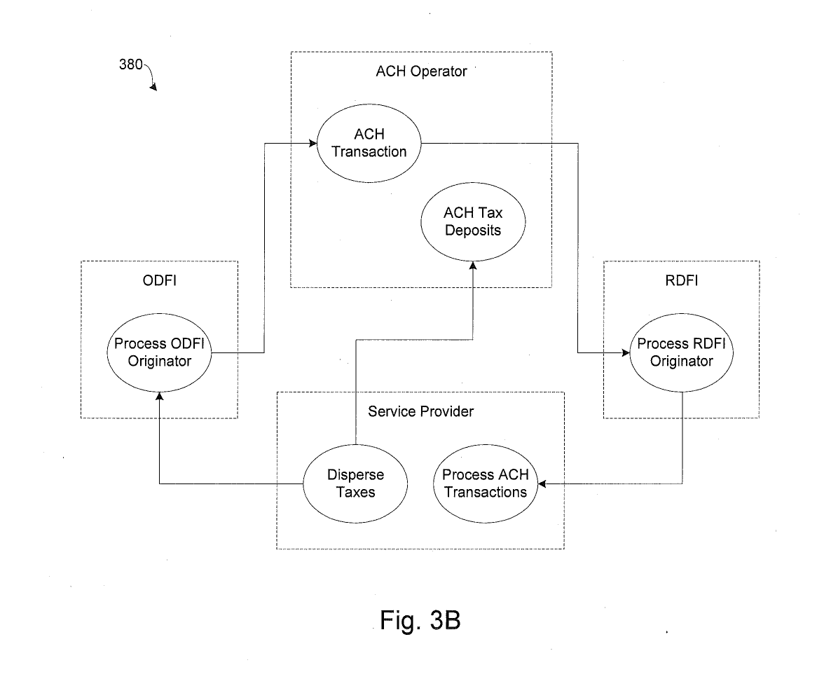

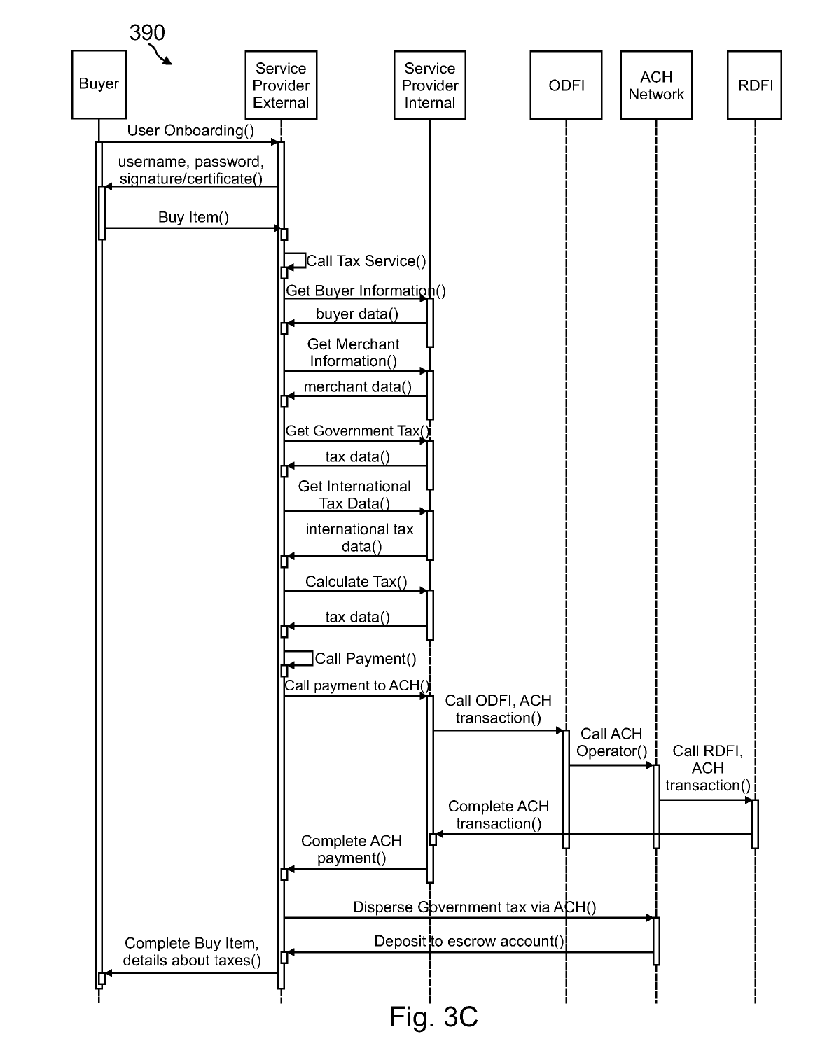

FIG. 3A shows one embodiment of a buy item process 300 for facilitating electronic commerce including facilitating tax status categorization over a network 160. It should be appreciated that, for purposes of explanation, the process 300 of FIG. 3A is described in reference to the system 100 of FIG. 1 and the methods 200, 220 of FIGS. 2A-2B, but should not be limited thereto.

In one implementation, a buyer 302 (e.g., a user interfacing with the user device 120) may establish a user account with a service provider 306, which may be referred to as buyer or user onboarding 310. For example, if the buyer 302 attempts to access the service provider 306 over the network 160, the buyer 302 may be prompted to establish a user account for login with the service provider 306, wherein the buyer 302 may use the user interface application 122 and the user device 120 to access the service provider 306 via the network 160. When establishing a user account, the buyer 302 may be asked to provide identity information including personal information, such as name, password, account number, location information (e.g., address), etc., and financial information, such as banking information, credit card information, etc.

Referring to FIG. 3A, the buyer 302 invokes a buy item service 312 via a merchant 304, which may be processed by the service provider 306. In various implementations, the merchant 304 is adapted to invoke the buy item service 312 on behalf of the buyer 302, and the buy item service 312 is adapted to invoke a tax service 314.

In one implementation, the tax service 314 is adapted to invoke one or more information services to obtain relevant buyer information 316 (e.g., buyer name, location, account information, etc.), obtain relevant merchant information 318 (merchant name, location, account information, etc.), obtain government tax information 320 (e.g., tax rates for federal, state, county, city, etc.), and obtain international tax information 322 (e.g., foreign monetary exchange rates and international tax rates for international country, province, city, town, etc.).

In another implementation, the tax service 314 is adapted to invoke a tax calculation service 330 based on one or more attributes related to obtained buyer information 316, obtained merchant information 318, obtained government tax information 320, and/or obtained international tax information 322. Tax may be calculated for the buyer 302 and one or more merchants associated with the buyer 302 via, for example, a buyer purchase. Tax may be calculated for one or more government entities 360, which may assume one or more tax entities for a transaction. Tax may be calculated for one or more international entities 362, which may assume one or more tax entities for a transaction.

In another implementation, the buy item service 312 calls the payment service 340, with relevant data and information, from the buyer 302, each merchant, and funding sources (e.g., ACH, etc.). In one aspect, the payment service 340 may be adapted to internally provide a risk and fraud analysis 342. In another aspect, ACH handling 360 is described in another process with reference to FIG. 3B. In another aspect, the payment service 340 calls the tax service 314 to disperse taxes 350 to one or more government and/or international entities via, for example, the government ACH 364 based on tax calculated for government and/or international entities in the tax calculation service 330.

It should be appreciated that the service provider 306 is adapted to process each event and/or service as described in reference to FIG. 3A. In various implementations, each service described herein may be processed by the processing module 184 in conjunction with the tax status categorization module 186. In various other implementations, each service described herein may be integrated as a separate module and/or integrated as part of the tax status categorization module 186, without departing from the scope of the present disclosure.

In one implementation, referring to FIG. 3A, a use case for the buy item service 312 may be initiated by the buyer 302 to the buy item service 312. For example, the buyer 302 may purchase an entity (e.g., item, product, and/or service) via the merchant 304, and a call to the buy item service 312 may be received by the service provider 306 via the merchant 304. The merchant 314 may include any type of online merchant in communication with the network 160. The merchant 314 calls the buy item service 312 of the service provider 306, which internally calls the tax service 314, which may be exposed externally, to compute taxes and disperse taxes to various government and international entities. In this use case, the disbursement shows an interaction with the ACH provider for transactions within the country of origin (e.g., the USA). Taxes may be dispersed to international disbursement entities 362 via, for example, international payment networks.

In various implementations, the service provider 306 is adapted to interact with different payment systems, such as NATCHA (electronic payments association), ACH, and various credit card processing networks, such as VISA and MasterCard. The service provider 306 is adapted to interact within the country of origin (e.g., the USA) and outside the country of origin (e.g., the USA) with government ACH providers and international tax repositories and providers.

In various implementations, the tax service 314 may be invoked by the service provider 306 in one or more different ways. For example, the buy item service 312 is adapted to call the tax service 314 and adapted to call the payment service 340. In another example, the payment service 340 may be adapted to call the tax service 314. In one aspect, the tax service 314 is exposed externally and may be integrated into various entities including merchants, consumers, governments, etc.

In accordance with embodiments of the present disclosure, systems and methods are adapted to provide a pluggable service for tax calculation, collection, and disbursement in the context of transactions, sales, and other services to various entities. Interactions may occur between consumer and merchant (e.g., shown as buy item use case), merchant and merchant (e.g., transaction between merchants), merchant and partners (e.g., transactions between aggregated merchants to partners), consumer and government (e.g., local/international tax calculation), merchant and government (e.g., local/international different use case, with WTO/UN rule sets), and between government and government. The usage scope may be within the USA as well as outside the USA to span international entities. The pluggable service may be utilized and integrated by any of the above entities so that accurate tax calculation may be achieved based on various integrations and use cases.

In accordance with embodiments of the present disclosure, systems and methods are adapted to provide a pluggable service through a service provider (e.g., PayPal) via a web service and/or API calls using, for example, Web 2.0 technologies. In various aspects, tax calculation, interaction, and disbursement may be based on one or more business rules (e.g., address verification) provided by the merchant. Merchant business rules may be fed to an engine for tax calculation and disbursement. Tax calculation, interaction, and disbursement may be based on buyer location, merchant location, and/or rules provided by the service provider. These rules may include rules from various counties, states, and/or international entities including trade agreements (e.g., WTO agreements). Business rules for disbursement may be based on payment networks to which the service provider integrates. In various other aspects, the tax calculation techniques provided herein involve locations from one or more involved entities and the originating transaction and/or service.

FIG. 3B shows one embodiment of a government tax dispersion process 380 for facilitating electronic commerce including facilitating tax status categorization over a network 160. It should be appreciated that, for purposes of explanation, the process 380 of FIG. 3B is described in reference to the system 100 of FIG. 1, the methods 200, 220 of FIGS. 2A-2B, and the process 300 of FIG. 3A, but should not be limited thereto.

In various implementations, the service provider is adapted to operate with and interact with one or more financial networks, such as the automated clearing house (ACH) network. The process 380 identifies interactions of the service provider with the ACH network for transaction processing and for utilizing the ACH network to deposit taxes for each financial transaction to an account (e.g., an escrow account) maintained by an ACH operator (e.g., the Federal Government).

Referring to the process 380 of FIG. 3B, the service provider, as Originator, is adapted to initiate an ACH transaction (e.g., debit and/or credit transaction). The Originating Depository Financial Institution (ODFI) is adapted to originate the transaction and transmits the transaction to the ACH network after receiving payment instructions from the service provider, as the Originator. The ACH Operators provide a central clearing facility for financial institutions. The ACH are adapted to receive transactions from the ODFI and route the transactions to an appropriate Receiving Depository Financial Institution (RDFI).

The RDFI is adapted to receive an ACH transaction (e.g., debit and/or credit) for posting to an account of the Receiver. The Receiver is a party that receives the ACH transaction (e.g., debit and/or credit). For example, the service provider may be referred to as a Receiver, if proxied via a Merchant. The service provider is adapted to directly interact with the ACH network to disperse taxes or go via the ODFI.

FIG. 3C shows one embodiment of a scenario flow 390 depicting an implementation of the buy item process 300 of FIG. 3A and the government tax dispersion process 380 of FIG. 3B for facilitating electronic commerce including facilitating tax status categorization over a network 160. It should be appreciated that, for purposes of explanation, the scenario flow 390 of FIG. 3C is described in reference to the system 100 of FIG. 1, the methods 200, 220 of FIGS. 2A-2B, and the processes 200, 280 of FIGS. 3A-3B, but should not be limited thereto.

Referring to FIG. 3C, scenario flow diagram 390 depicts a flow for activity for the buy item process 300 of FIG. 3A and the government tax dispersion process 380 of FIG. 3B. The buy item service 312 is adapted to invoke the tax service 314, which is adapted to internally utilize metadata from various entities, such as the buyer, merchant, government entities (e.g., internal and/or external) with foreign exchange rates, as per transaction requirements. The depicted scenario flow 390 is adapted to utilize the ACH network.

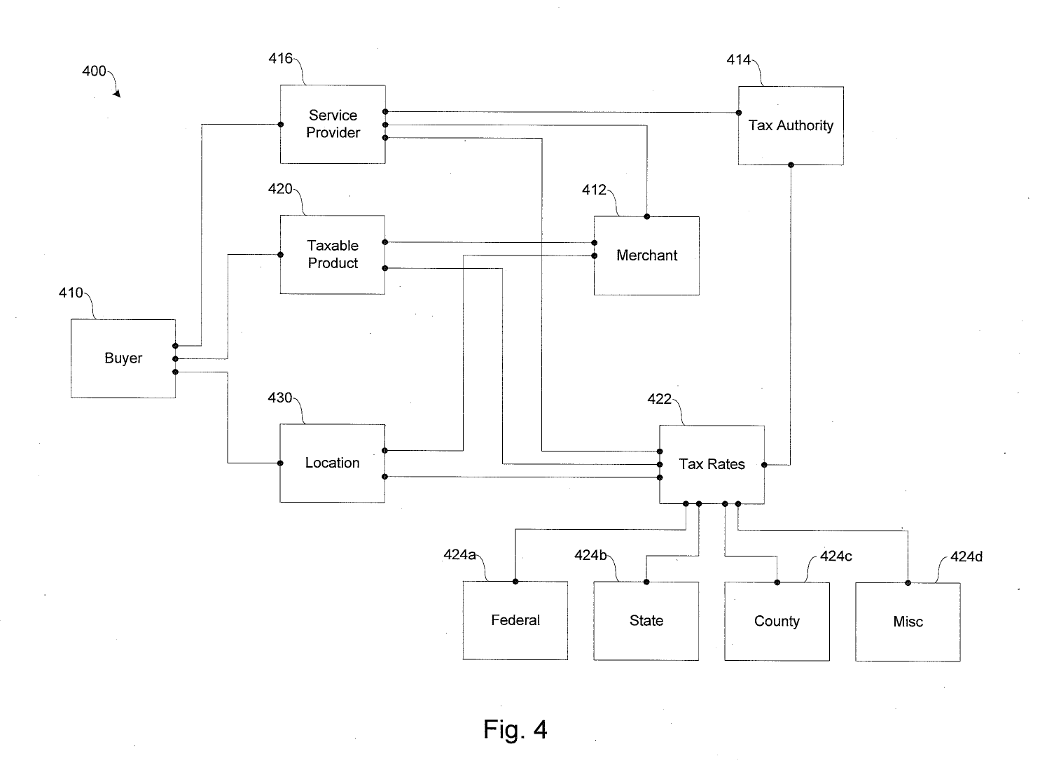

FIG. 4 shows one embodiment of a tax service system 400 adapted for facilitating electronic commerce including facilitating tax status categorization over a network, such as the Internet and/or a mobile communication network. It should be appreciated that, for purposes of explanation, the system 400 of FIG. 4 is described in reference to the system 100 of FIG. 1, the methods 200, 220 of FIGS. 2A-2B, and the processes 200, 280, 290 of FIGS. 3A-3C, but should not be limited thereto.

Referring to FIG. 4, the system 400 interacts with different entities within the process of facilitating tax status categorization over the network. In one implementation, a buyer 410 (e.g., user, client, consumer, customer, etc.) includes an individual or purchasing entity that is adapted to acquire items, products, and/or services over the network. A merchant 412 (e.g., seller, etc.) includes an individual or proffering entity that is adapted to proffer one or more items, products, and/or services for purchase over the network. A tax authority 414 (e.g., government authority) includes one or more authorized taxing entities that are adapted to collect taxes and/or other fees to be added to the sale of the items, products, and/or services over the network. A service provider 416 (e.g., payment processor and/or tax assessor) includes a transaction processing entity that is adapted to process payments and assess taxes for financial transactions between the buyer 410 and the merchant 412 over the network. In one aspect, the service provider 416 may be adapted to calculate tax amounts and/or fees, collect taxes and/or fees, and transfer collected taxes and/or fees into an account (e.g., an escrow account) for dispersion to the one or more tax authorities 414.

In one aspect, referring to FIG. 4, the merchant 412 may proffer one or more taxable items, products, and/or services 420 for purchase over the network. The buyer 410 is adapted to view and purchase one or more of the taxable items, products, and/or services 420 over the network. The tax authority 414 is adapted to apply one or more different tax rates 422 to the taxable items, products, and/or services 420 based on a location 430 of the buyer 410 and/or the merchant 412. The tax authority 414 is further adapted to apply one or more different tax rates 422 to the taxable items, products, and/or services 420 based on the type of taxable items, products, and/or services 420 proffered for sale by the merchant 412. In various implementations, the tax rates may include one or more of federal (i.e., central) tax rates 424a, state tax rates 424b, county tax rates 424c, and other miscellaneous tax rates 424c based on the type of taxable items, products, and/or services 420 proffered for sale. It should be appreciated by those skilled in the art that the tax rates 422 may include various other government based tax rates, such as province tax rates, city tax rates, town tax rates, etc., and international tax rates, such as foreign tax rates, foreign exchange rates, etc., without departing from the scope of the present disclosure.

In various embodiments, the tax service system 400 provides an exclusive tax based service to merchants and governments over a network that enables effective implementation and management of complex network based taxation models. The tax service system 400 interacts with government entities and other taxing authorities to provide efficient taxation models. The tax service system 400 may also provide revenue streams for licensing, service usage, escrow account fees, etc. The tax service system 400 may be adapted to maintain a competitive advantage by providing a rule set for taxation over the Internet.

In one example, the service provider may implement a tax service for network based financial transactions in a manner as follows. In this scenario, a purchaser residing in the state of California is attempting to purchase a large screen television via the Internet from a seller residing in the state of Oregon.

Presently, the California state government has determined that reducing the number of large screen televisions in the state may reduce energy consumption for the state. The California state government has addressed this issue by limiting the size of televisions. One challenge of trying to accomplish this effort through laws instead of taxes is that consumers may purchase a large screen television from another state via the Internet and have it shipped to California. As such, increased taxes may curb the desire for larger televisions.

With implementation of the tax service, the California state government may impose a large tax (e.g., 20% tax) on televisions exceeding a pre-determined size that are sold to purchaser living in California. A standard retail store may impose the large tax on purchase of these televisions. For those that are purchasing these televisions over the Internet, the merchant may use the tax service to determine the location of the purchaser. If the ship to address is California, than the tax service may apply the large tax on the purchase of the television. The tax may be put into an escrow account by the service provider and paid to the state of California.

Moreover, there may be another tax (e.g., a 3% sales tax) for all non-consumable products that are sold from within the state of Oregon. The tax service of the service provider is adapted to apply both taxes (e.g., the 20% tax for California and the 3% sales tax for Oregon) to the purchase of the television, and both taxes collected are put into an escrow account for the respective government taxing authorities.

In another example, the service provider may implement the tax service for network based financial transactions in another manner as follows. In this scenario, a purchaser residing in the city of San Francisco in the state of California in the country of the United States of America is attempting to purchase one or more packs of cigarettes via the Internet from a seller residing in the city of London in the country of England.

Presently, local, state, and federal governments are seeking reduced consumption of tobacco products, such as cigarettes. An effective tool in curbing tobacco use is imposition of taxes, which may be imposed with sales taxes and stamps that authorize the sale and use of these products. Typically, these types of sales taxes and stamp taxes are fairly cumbersome and expensive to implement and manage.

In this example, a purchaser is attempting to buy hand-made, custom cigarettes from a manufacturer in the country of England. The purchaser accesses an Internet website of the manufacturer and orders one or more cigarette packs online to be shipped to California. The manufacturer in England may use the tax service of the service provider to automatically calculate the taxes in a manner as follows.

For a pack of cigarettes that are sold in London, England:
London imposes a $0.02 tax per pack of cigarettes, and
England imposes a 4% tax per pack of cigarettes.

For a pack of cigarettes that are sold to someone in San Francisco, Calif., USA:
USA has a 5% tax per pack of cigarettes,
California has a $0.20 tax per pack of cigarettes, and
San Francisco has a $0.80 tax per pack of cigarettes.

The total tax for each pack of cigarettes that lists as $1.00 per pack of cigarettes is:

($1.00*0.04)+($1.00*0.05)+$0.02+$0.20+$0.80)=$1.11 tax per pack.

This may be represented by ((Base Price*UK tax)+(Base Price*US tax)+London Tax+California tax+San Francisco tax).

In this scenario, the tax may be collected by the service provider and put into separate escrow accounts by the service provider for each of the government tax entities.

The tax service of the service provider is adapted to allow each government entity to determine the level of taxes. The tax service is adapted to allow each government entity to set a maximum amount of taxes or a minimum amount that may be applied to the purchase of a specific product or type of product. The tax service is adapted to provide flexibility to the applications of taxes to products based on revenue needs, social engineering, encouraging technical directions, etc.

In one implementation, tax calculations may be based on tax data and information stored in a database, and tax rates may be calculated by the service provider based on one or more of the following entities: tax bodies with rates and categories; items, products, and services, and categories therein; merchant location and shipping location; purchaser location and shipped to location; and foreign monetary exchange rates.

The service provider may utilize a relational database adapted to identify government entities with respective taxes, such as specific taxes and categorical taxes. The relational database may include tax rates based on location of buyer and/or seller.

The service provider may utilize a relational database adapted to identify products and categories of the products. One example includes food products versus non-consumable products. The classification of the item, product, and/or service is defined to enable proper tax calculations. It should be appreciated that different governments may classify items, products, and/or services differently. For example, some tax entities may consider candy a consumable product, and conversely, other tax entities may consider candy a non-consumable product. These data and information entities may be used for tax calculations and may use processes and applications to enable maintenance and management.

In various embodiments, tax entities may include one or more of federal governments, state governments, province governments, territory governments, county governments, municipal governments, city governments, town governments, sanctioned international entities (e.g., the United Nations (UN)), and/or various other entities with the authority to assess, collect, and use tax revenue and/or fee revenue.

In various embodiments, items, products, and/or service including classifications thereof may include one or more of consumer products, intellectual capital, bulk products, copyright products, leased products, rented products, services, and/or any other item, product and/or service that is transferred in return for money or value.

In various embodiments, existing entities that may be used for calculating taxes may include one or more of a merchant having an associated shipping or business address and a service provider customer having a receiving address.

In one embodiment, a table may be utilized to identify and/or describe attributes of different entities as follows, in reference to the cigarette example described above.

| Tax Body | | Product or Category Cigarettes Pack | | |
|---|---|---|---|---|
| Type | Name | Sell From | Purchase To | Other |
| Federal | England | 4% | 10% | |
| | US | 8% | 5% | |
| | Japan | 0% | 20% | |
| State or Provence | CA | $.04 | $.20 | |
| | WA | $.02 | $.80 | |
| | MN | $.06 | $.03 | |
| Municipal | San Francisco | $.80 | $.80 | |
| | London | $.02 | $1.20 | |
| | Seattle | $.03 | $.05 | |

In one aspect, the table above provides an example of tax rates and configuration of tax rate data and information based on location of buyer and seller. It should be appreciated that the above listed tax rates provide an example of applicable tax rates, and the tax rates may be altered, changed, or comprise some other value, without departing form the scope of the present disclosure. It should also be appreciated that the table may have one or more additional tax entities and may have tax rates listed in the currency of the country that applies the tax. This tax rate data and information may be stored in a relational database, and the tax service application may automatically compute the taxes. The service provider may maintain the tax tables, and the tax entities may provide updated tax rate data and information to the service provider for application to the tax table.

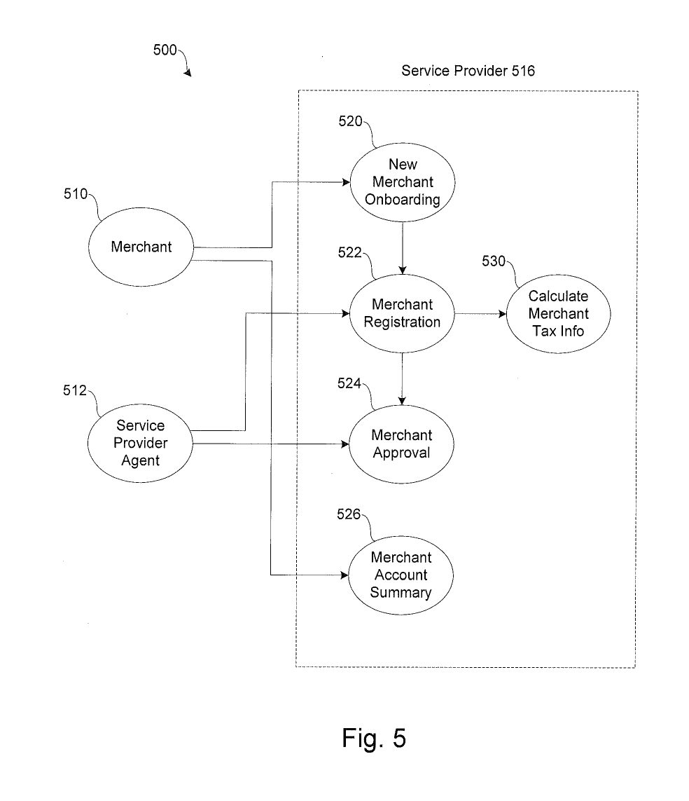

FIG. 5 shows one embodiment of a merchant onboarding process 500 adapted for facilitating electronic commerce including facilitating tax status categorization over a network, such as the Internet and/or a mobile communication network. It should be appreciated that, for purposes of explanation, the system 500 of FIG. 5 is described in reference to the system 100 of FIG. 1, methods 200, 220 of FIGS. 2A-2B, processes 200, 280, 290 of FIGS. 3A-3C, and system 400 of FIG. 4, but should not be limited thereto.

Referring to FIG. 5, a merchant 510 interacts with an agent 512 associated with a service provider 516. The process 500 involves new merchant onboarding 520, which is adapted to register a new merchant account with the merchant 510. The process 500 involves the buy item service to purchase an item, product, and/or service using the tax service of the service provider 516. The process 500 involves dispersion of taxes to government tax entities via the automated clearing house (ACH).

In one implementation, the merchant onboarding process 500 involves the merchant 510 initiating a new merchant onboarding account process 520. The service provider 516 is adapted to register a new merchant account with the merchant 510.

The process 500 involves a merchant registration process 522 adapted to collect data and information related to the merchant 510. The process 500 may be adapted to determine, identify, and/or calculate tax data and information 530 pertaining to the merchant 510.

The service provider agent 512 is adapted to review the merchant application 512 for acceptance or rejection. After analysis, the merchant 510 may be approved 524 for a merchant account with the service provider 516, wherein the merchant account includes, as stored therewith, merchant credentials (e.g., merchant name, authorized users, passwords, signatures, certificates, security data, etc.).

After approval, the merchant 510 may review a merchant account summary 526 adapted to summarize the services made available to the merchant 510. Other merchant services may be reviewed by the service provider agent 512 and provided as part of the merchant account summary 526, which is made available to the merchant 510.

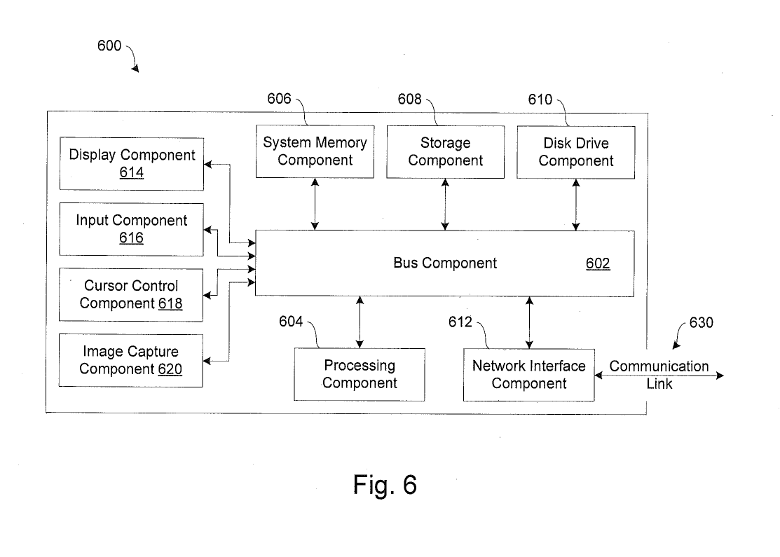

FIG. 6 is a block diagram of a computer system 600 suitable for implementing various embodiments of the present disclosure, including the user device 120, the merchant devices 140, and the service provider device 180. In various implementations, the user device 120 may comprise a network communication device (e.g., mobile cellular phone, laptop, personal computer, etc.) capable of communicating with the network 160, the merchant devices 140 may comprise a network computing device (e.g., a network server), and the service provider device 180 may comprise a network computing device (e.g., a network server). In other implementations, it should be appreciated that the merchant devices 140 and the service provider device 180 may comprise a network communication device (e.g., mobile cellular phone, laptop, personal computer, etc.) capable of communicating with the network 160, without departing from the scope of the present disclosure. Hence, it should be appreciated that each of the devices 120, 140, 180 may be implemented as the computer system 600 for communication with the network 160 in a manner as follows.

In accordance with various embodiments of the present disclosure, computer system 600, such as a mobile communication device and/or a network server, includes a bus 602 or other communication mechanism for communicating information, which interconnects subsystems and components, such as processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., CRT or LCD), input component 616 (e.g., keyboard), cursor control component 618 (e.g., mouse or trackball), and image capture component 620 (e.g., analog or digital camera). In one implementation, disk drive component 610 may comprise a database having one or more disk drive components.

In accordance with embodiments of the present disclosure, computer system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of or in combination with software instructions to implement the present disclosure.

Logic may be encoded in a computer readable medium, which may refer to any medium that participates in providing instructions to processor 604 for execution. Such a medium may take many forms, including but not limited to, non-volatile media and volatile media. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for facilitating electronic commerce over a network, the method comprising:
communicating with a user via a user device and a merchant via a merchant device over the network;
receiving a purchase request from the user via the user device over the network;
determining tax parameters for the purchase request based on information related to the location of the user, the location of the merchant, and the type of item requested for purchase in the purchase request;
automatically calculating tax for the purchase request based on the tax parameters;
processing the purchase request; and
storing transaction information related to the processed purchase transaction including tax information.

2. The method of claim 1, further comprising:
obtaining user information from the purchase request; and
notifying the user of tax information over the network including the tax parameters and the calculated tax for the purchase request based on the tax parameters.

3. The method of claim 1, further comprising:
obtaining merchant information from the purchase request; and
notifying the merchant of tax information over the network including the tax parameters and the calculated tax for the purchase request based on the tax parameters.

4. The method of claim 1, further comprising:
obtaining tax entity information from the purchase request;
identifying one or more tax entities related to the purchase request based on the location of the user, the location of the merchant, and the type of item requested for purchase in the purchase request; and
notifying one or more tax entities of tax information over the network including the tax parameters and the calculated tax for the purchase request based on the tax parameters.

5. The method of claim 1, further comprising:
receiving payment for one or more items requested for purchase in the purchase request including payment for tax;
dispersing tax to one or more tax entities related to the purchase request based on the location of the user, the location of the merchant, and the type of item requested for purchase in the purchase request; and
storing transaction information related to the received payment including the payment for tax and the dispersion of tax.

6. The method of claim 1, further comprising:
applying a plurality of different tax rates to the purchase request based on information related to the location of the user, the location of the merchant, and the type of item requested for purchase in the purchase request.

7. The method of claim 1, further comprising:
applying a first tax rate to the purchase request based on information related to the location of the user,
applying a second tax rate is applied to the purchase request based on information related to the location of the merchant, and
applying a third tax rate is applied to the purchase request based on information related to the type of item requested for purchase in the purchase request.

8. The method of claim 1, further comprising:
prompting the user to login over the network after receiving the purchase request from the user via the user device over the network;
receiving user information including user identity information from the user via the user device over the network;
verifying the identity of the user based on the user information; and
verifying a user account related to the user.

9. The method of claim 1, wherein the transaction information including the tax information is stored as part of an account related to the user, and the account related to the user includes information related to the user including identification information.

10. The method of claim 1, wherein the method is performed by a network server adapted to communicate with the user device and the merchant device over the network.

11. A system for facilitating electronic commerce over a network, the system comprising:
means for communicating with a user via a user device and a merchant via a merchant device over the network;
means for receiving a purchase request from the user via the user device over the network;
means for determining tax parameters for the purchase request based on information related to the location of the user, the location of the merchant, and the type of item requested for purchase in the purchase request;
means for automatically calculating tax for the purchase request based on the tax parameters;
means for processing the purchase request; and
means for storing transaction information related to the processed purchase transaction including tax information.

12. The system of claim 11, further comprising:
means for obtaining user information from the purchase request; and
means for notifying the user of tax information over the network including the tax parameters and the calculated tax for the purchase request based on the tax parameters.

13. The system of claim 11, further comprising:
means for obtaining merchant information from the purchase request; and
means for notifying the merchant of tax information over the network including the tax parameters and the calculated tax for the purchase request based on the tax parameters.

14. The system of claim 11, further comprising:
means for obtaining tax entity information from the purchase request;
means for identifying one or more tax entities related to the purchase request based on the location of the user, the location of the merchant, and the type of item requested for purchase in the purchase request; and
means for notifying one or more tax entities of tax information over the network including the tax parameters and the calculated tax for the purchase request based on the tax parameters.

15. The system of claim 11, further comprising:
means for receiving payment for one or more items requested for purchase in the purchase request including payment for tax;
means for dispersing tax to one or more tax entities related to the purchase request based on the location of the user, the location of the merchant, and the type of item requested for purchase in the purchase request; and
means for storing transaction information related to the received payment including the payment for tax and the dispersion of tax.

16. The system of claim 11, further comprising:
means for applying a plurality of different tax rates to the purchase request based on information related to the location of the user, the location of the merchant, and the type of item requested for purchase in the purchase request.

17. The system of claim 11, further comprising:
means for applying a first tax rate to the purchase request based on information related to the location of the user,
means for applying a second tax rate is applied to the purchase request based on information related to the location of the merchant, and
means for applying a third tax rate is applied to the purchase request based on information related to the type of item requested for purchase in the purchase request.

18. The system of claim 11, further comprising:
means for prompting the user to login over the network after receiving the purchase request from the user via the user device over the network;
means for receiving user information including user identity information from the user via the user device over the network;
means for verifying the identity of the user based on the user information; and
means for verifying a user account related to the user.

19. The system of claim 11, wherein the transaction information including the tax information is stored as part of an account related to the user, and the account related to the user includes information related to the user including identification information.

20. The system of claim 11, comprising a network server adapted to communicate with the user device and the merchant device over the network.

21. A computer readable medium on which are stored computer readable instructions and when executed operable to:
communicate with a user via a user device and a merchant via a merchant device over a network;
receive a purchase request from the user via the user device over the network;
determine tax parameters for the purchase request based on information related to the location of the user, the location of the merchant, and the type of item requested for purchase in the purchase request;
automatically calculate tax for the purchase request based on the tax parameters;
process the purchase request; and
store transaction information related to the processed purchase transaction including tax information.

22. The computer readable medium of claim 21, further operable to:
obtain tax entity information from the purchase request;
identify one or more tax entities related to the purchase request based on the location of the user, the location of the merchant, and the type of item requested for purchase in the purchase request; and
notify one or more tax entities of tax information over the network including the tax parameters and the calculated tax for the purchase request based on the tax parameters.

23. The computer readable medium of claim 21, further operable to:
receive payment for one or more items requested for purchase in the purchase request including payment for tax;
disperse tax to one or more tax entities related to the purchase request based on the location of the user, the location of the merchant, and the type of item requested for purchase in the purchase request; and
store transaction information related to the received payment including the payment for tax and the dispersion of tax.

24. The computer readable medium of claim 21, further operable to:
apply a plurality of different tax rates to the purchase request based on information related to the location of the user, the location of the merchant, and the type of item requested for purchase in the purchase request.

25. The computer readable medium of claim 21, further operable to:
apply a first tax rate to the purchase request based on information related to the location of the user,
apply a second tax rate is applied to the purchase request based on information related to the location of the merchant, and
apply a third tax rate is applied to the purchase request based on information related to the type of item requested for purchase in the purchase request.
